(19) United States
(12) Patent Application Publication
(10) Pub. No.: US 2006/0038634 A1
(43) Pub. Date: Feb. 23, 2006

(54) Antenna control unit and phased-array antenna

(75) Inventor: Hideki Kirino, Ayauta-gun (JP)

Correspondence Address: WENDEROTH, LIND & PONACK, L.L.P., 2033 K STREET N. W., SUITE 800, WASHINGTON, DC, 20006-1021, US

(73) Assignee: MATSUSHITA ELECTRIC INDUSTRIAL CO., LTD, (omitted)

(21) Appl. No.: 10/515,482

(22) PCT Filed: Jun. 13, 2003
(86) PCT No.: PCT/JP03/07540

§ 371 Date: Nov. 24, 2004

(30) Foreign Application Priority Data
Jun. 13, 2002 (JP) 2002-172424

(51) Int. Cl. H01P 1/18

(52) U.S. Cl. 333/164; 342/375

(57) ABSTRACT

As shown in FIG. 1, a paraelectric transmission line layer 102 and a ferroelectric transmission line layer 105 are laminated through a ground conductor 107, and plural phase shifters which are connected via through holes 108 that pass through the ground conductor 107 are disposed on both of the transmission line layers at some positions on a feeding line that branches off from the input terminal between all antenna terminals and an input terminal to which a high-frequency power is applied. In addition, loss elements each having the same transmission loss amount as the phase shifter, or the phase shifters are disposed so that transmission loss amounts from all of the antenna terminals to the input terminal are equalized. Accordingly, an antenna control unit which can be manufactured in fewer manufacturing processes and has a pointed beam and a large beam tilt amount, and a phased-array antenna that employs such antenna control unit can be obtained.

### TECHNICAL FIELD

The present invention relates to an antenna control unit that employs a ferroelectric as a phase shifter, and a phased-array antenna that utilizes such antenna control unit. More particularly, this invention relates to an antenna control unit such as mobile unit identifying radio or automobile collision avoidance radar, and a phased-array antenna that utilizes such antenna control unit.

### BACKGROUND ART

Systems such as “Active phased-array antenna and antenna control unit” described in Japanese Published Patent Application No. 2000-236207 (hereinafter, referred to as Prior Art 1) have been suggested as examples of conventional phased-array antennas that employ a ferroelectric as a phase shifter.

Hereinafter, a conventional phased-array antenna will be described with reference to FIGS. 9 and 10.

Initially, with reference to FIGS. 9, operating principles of a conventional phase shifter are described. FIGS. 9 are diagrams illustrating a phase shifter that is suggested in the conventional phased-array antenna. FIG. 9(a) is a diagram illustrating a construction of the phase shifter, and FIG. 9(b) is a diagram showing permittivity changing characteristics of a ferroelectric material.

This phase shifter 700 includes a microstrip hybrid coupler 703 that employs a paraelectric material 701 as a base material, and a microstrip stub 704 that employs a ferroelectric material 702 as a base material and is formed adjacent to the microstrip hybrid coupler 703. This phase shifter 700 is constituted such that a phase shift amount of a high-frequency power that passes through the microstrip hybrid coupler 703 varies according to a DC control voltage which is applied to the microstrip stub 704.

In other words, the base material of the phase shifter 700 is composed of the paraelectric material 701 and the ferroelectric material 702. A rectangular loop-shaped conductor layer 703a is disposed on the paraelectric base material 701, and this loop-shaped conductor layer 703a and the paraelectric base material 701 form the microstrip hybrid coupler 703.

Further, two linear conductor layers 704a1 and 704a2 are disposed on the ferroelectric base material 702 so as to be located on extension lines of two opposed linear parts 703a1 and 703a2 of the rectangular loop-shaped conductor layer 703a and linked to one ends of the two linear parts 703a1 and 703a2, respectively. These two linear conductor layers 704a1 and 704a2 and the ferroelectric base material 702 form the microstrip stub 704.

Further, conductor layers 715a and 720a are disposed on the paraelectric base material 701 so as to be located on extension lines of the two linear parts 703a1 and 703a2 and linked to the other ends of the two linear parts 703a1 and 703a2, respectively.

This conductor layer 715a and the paraelectric base material 701 form an input line 715, and the conductor layer 720a and the paraelectric base material 701 form an output line 720.

Here, the one end and the other end of the linear part 703a1 on the loop-shaped conductor layer 703a are ports 2 and 1 of the microstrip hybrid coupler 703, respectively. On the other hand, the one end and the other end of the linear parts 703a2 of the loop-shaped conductor layer 703a are ports 3 and 4 of the microstrip hybrid coupler 703, respectively.

In the phase shifter 700 having the above-mentioned construction, when the DC control voltage is applied to the microstrip stub 704, the phase shift amount of the high-frequency power that passes therethrough varies.

Hereinafter, a detailed explanation will be given. In the phase shifter 700 having such a construction that one reflection element (microstrip stub 704) is connected to the adjacent two ports (ports 2 and 3) of the properly-designed microstrip hybrid coupler 703, a high-frequency power that enters from the input port (port 1) is not outputted from the input port 1 but the high-frequency power upon which a power reflected from the reflection element has been reflected is outputted only from the output port (port 4). In the reflection from the microstrip stub 704 as the reflection element, a bias field 705 that is produced by the control voltage is in the same direction as that of a field produced by the high-frequency power that passes through the microstrip stub 704, as shown in FIG. 9(a). Therefore, as shown in FIG. 9(b), when the control voltage is changed, an effective permittivity of the microstrip stub 704 with respect to the high-frequency power varies adaptively. Accordingly, the equivalent electrical length of the microstrip stub 704 for the high-frequency power varies, and the phase on the microstrip stub 704 is changed.

In the case of common ferroelectric base materials, the bias voltage 705 that is required to change the effective permittivity of the microstrip stub 704 is in a rage of several kilovolts/millimeter to dozen kilovolts/millimeter. Accordingly, no high frequency is produced by the effective permittivity that is affected by a field formed by the high-frequency power which passes through the microstrip stub 704.

Next, a construction of the conventional phased-array antenna and its operating principles will be described with reference to FIGS. 10.

FIG. 10(a) is a diagram illustrating a construction of the conventional phased-array antenna, and FIG. 10(b) is a diagram showing directivities of the conventional phased-array antenna in a case where a beam tilt voltage is applied and a case where the beam tilt voltage is not applied.

The conventional phased-array antenna 830 comprises plural antenna elements 806a-806d which are placed in a row at regular intervals on a dielectric base material, an antenna control unit 800, and a beam tilt voltage 820. The antenna control unit 800 comprises a feeding terminal 808 to which a high-frequency power is applied (hereinafter, referred to as an input terminal), a high frequency blocking element 809, and plural phase shifters 807a1-807a4.

In this conventional phased-array antenna 830, the antenna element 806a is connected to the input terminal 808, the antenna element 806b is connected to the input terminal 808 through one phase shifter 807a1, the antenna element 806c is connected to the input terminal 808 through two phase shifters 807a3 and 807a4, and the antenna element 806d is connected to the input terminal 808 through three phase shifters 807a2, 807a3, and 807a4, by means of a feeding line (hereinafter, referred to as a transmission line), respectively. The beam tilt voltage 820 is connected to the input terminal 808 through the high frequency blocking element 809.

It is assumed here that each construction of the phase shifters 807a1-807a4 is the same as that described with reference to FIG. 9, and the phase shifters 807a1-807a4 have the same characteristics.

In the phased-array antenna 830 having the above construction, the number of phase shifters 807 which are located between one of the antenna elements 806a-806d and the input terminal 808 is one larger than the number of phase shifters 807 which are located between the adjacent antenna element 806 and the input terminal 808, respectively, and further, all of the phase shifters 807 have the same characteristics. Therefore, as shown in FIG. 10(b), the control of the antenna's directivity (beam tilt) is performed by one beam tilt voltage 820.

The control of the antenna directivity will be described in more detail. For example, assuming that each of the phase shifters 807a1-807a4 delays the phase of the high-frequency power that passes through each phase shifter by a phase shift amount Φ and the adjacent phase shifters 807 are spaced by a distance d, respectively, the high-frequency power that has entered the antenna element 806a is supplied to the input terminal 808 with no phase change, as shown in FIG. 10(a). In contrast to this, the high-frequency power that has entered the antenna element 806b is supplied to the input terminal 808, with its phase being delayed by the phase shifter 807a1 by a phase shift amount Φ. The high-frequency power that has entered the antenna element 806c is supplied to the input terminal 808, with its phase being delayed by the phase shifters 807a3 and 807a4, by a phase shift amount 2Φ. Further, the high-frequency power that has entered the antenna element 806d is supplied to the input terminal 808, with its phase being delayed by the phase shifters 807a2, 807a3, and 807a4, by a phase shift amount 3Φ.

In other words, a direction of the maximum sensitivity for radio waves received by the antenna elements 806a-806d is a direction D that forms a predetermined angle Θ (Θ=cos⁻¹(Φ/d)) with respect to the direction of the row of the antenna elements 806a-806d. It is assumed here that references w1 to w3 in FIG. 10(a) denote planes of the received waves in the same phase, respectively.

However, in the conventional phased-array antenna 803 having the above-mentioned construction, the numbers of phase shifters 807 which are located between the respective antenna elements 806 and the input terminal 808 are different, and further there are transmission losses in the respective phase shifters 807. Therefore, the effects of combining powers from the respective antenna elements 806a-806d are decreased, so that the shape of the beam that is shown in FIG. 10(b) is deformed, whereby it is difficult to obtain a pointed beam (large directivity gain), as well as the amount of beam tilt is reduced, and accordingly the control of the antenna's directivity is deteriorated.

Further, as described with reference to FIG. 9(a), each of the phase shifters 807 that are used for the conventional phased-array antenna 830 is formed in one piece, by allocating areas on the same plane to the ferroelectric base material 702 and the paraelectric base material 701 which constitute the phase shifter 700, respectively. Therefore, a distributed capacitance Cn per unit length of the line for the microstrip hybrid coupler 703 and a distributed capacitance Cf per unit length of the line for the microstrip stub 704 are greatly different from each other. Accordingly, high-frequency power reflection is produced at the connection between the microstrip hybrid coupler 703 and the microstrip stub 704, whereby the power from the microstrip hybrid coupler 703 does not enter the microstrip stub 704 so efficiently, and consequently the sufficient phase shift amount cannot be obtained.

Hereinafter, a detailed explanation will be given. For, example, the line impedance Z is generally expressed by the distributed inductance L per unit length of the line and the distributed capacitance C per unit length of the line as Zˆ2 (the square of Z)=L/C. Further, when it is assumed that all fields exist only within the base material, and all of the fields are approximated to be linear and perpendicular to the ground conductor, the distributed capacitance C per unit length of the line is expressed by the line width W, the base material thickness H, and the base material permittivity ε, as C=εW/H. When the distributed capacitance Cn per unit length of the line for the microstrip hybrid coupler 703 and the distributed capacitance Cf per unit length of the line for the microstrip stub 704 are compared with each other by utilizing the above-mentioned expressions, assuming that the permittivity of the paraelectric base material 701 as the base material of the microstrip hybrid coupler 703 is εn and the permittivity of the ferroelectric base material 702 as the base material of the microstrip stub 704 is εf, the relationship εn<<εf is generally established. Further, since the line widths W of the microstrip hybrid coupler 703 and the microstrip stub 704, and the distances H of the respective conductors are the same, the distributed capacitance Cn per unit length of the line for the microstrip hybrid coupler 703 (=εnW/H) and the distributed capacitance Cf per unit length of the line for the microstrip stub 704 (=εfW/H) are greatly different. Consequently, as mentioned above, the power from the microstrip hybrid coupler 703 does not enter the microstrip stub 704 so efficiently, and thus the sufficient phase shift amount cannot be obtained.

To overcome this problem, the method in which a magnetic material is provided in proximity of the microstrip stub 704 to increase the distributed inductance L per unit length of the line for the microstrip stub 704, thereby enhancing the line impedance Z, is disclosed in the above-mentioned Prior Art 1, and its construction is also suggested therein.

However, when the magnetic material is provided in proximity of the microstrip stub 704 of the phase shifter 700 to suppress the reduction in the matching degree of the line impedance Z between the both line sections 703 and 704, so as to obtain a larger phase shift amount, as in the above-mentioned Prior Art 1, there arises an additional problem that more processes are needed when the phase shifter 700 is produced by firing, and accordingly the manufacturing cost of the phase shifter is adversely increased.

The present invention is made to solve the abovementioned problems, and this invention has for its object to provide an antenna control unit that can be manufactured in fewer manufacturing processes (low cost), and has a pointed beam (large directivity gain) and a large amount of beam tilt, and a phased-array antenna that employs such an antenna control unit.

### DISCLOSURE OF THE INVENTION

According to Claim 1 of the present invention, there is provided an antenna control unit including plural antenna terminals to which antenna elements are connected, a feeding terminal to which a high-frequency power is applied, and phase shifters which are connected to the respective antenna terminals by feeding lines that branch off from the feeding terminal and electrically change a phase of a high-frequency signal that passes through between the respective antenna terminals and the feeding terminal, this phase shifters being placed at some positions on the respective feeding lines, in which this phase shifter includes: a hybrid coupler on a paraelectric transmission line layer that employs a paraelectric material as a base material; and a stub on a ferroelectric transmission line layer that employs a ferroelectric material as a base material, the paraelectric transmission line layer and the ferroelectric transmission line layer are laminated through a ground conductor, and the hybrid coupler and the stub are connected via a through hole that passes through the ground conductor, and a distance between conductors that form a transmission line on the ferroelectric transmission line layer is larger than a distance between conductors that form a transmission line on the paraelectric transmission line layer.

Therefore, it is possible to obtain a low-cost phase shifter which provides an effective phase shift amount as well as is manufactured in few processes, and consequently an antenna control unit can be manufactured in few processes, whereby the manufacturing cost of the antenna control unit can be reduced.

According to Claim 2 of the present invention, there is provided an antenna control unit including plural antenna terminals to which antenna elements are connected, a feeding terminal to which a high-frequency power is applied, and phase shifters which are connected to the respective antenna terminals by feeding lines that branch off from the feeding terminal and electrically change a phase of a high-frequency signal that passes through between the respective antenna terminals and the feeding terminal, this phase shifters being placed at some positions on the respective feeding lines, in which this phase shifter includes: a hybrid coupler on a paraelectric transmission line layer that employs a paraelectric material as a base material; and a stub on a ferroelectric transmission line layer that employs a ferroelectric material as a base material, the paraelectric transmission line layer and the ferroelectric transmission line layer are laminated through a ground conductor, and the hybrid coupler and the stub are electromagnetically connected via a coupling window that is formed on the ground conductor, and a distance between conductors that form a transmission line on the paraelectric transmission line layer is larger than a distance between conductors that form a transmission line on a ferroelectric transmission line layer.

Therefore, it is possible to obtain a lower-cost phase shifter that provides a more effective phase shift amount as well as is manufactured in fewer processes, and consequently an antenna control unit can be manufactured in fewer processes, whereby the manufacturing cost of the antenna control unit can be reduced.

According to Claim 3 of the present invention, there is provided a phased-array antenna that includes, on a dielectric substrate: plural antenna elements; and an antenna control unit having a feeding terminal to which a high-frequency power is applied, and phase shifters that are connected with the respective antenna elements by feeding lines which branch off from the feeding terminal and electrically change a phase of a high-frequency signal that passes through between the respective antenna elements and the feeding terminal, this phase shifters being placed at some positions on the feeding lines, in which this phase shifter includes: a hybrid coupler on a paraelectric transmission line layer that employs a paraelectric material as a base material; and a stub on a ferroelectric transmission line layer that employs a ferroelectric material as a base material, the paraelectric transmission line layer and the ferroelectric transmission line layer are laminated through a ground conductor, and the hybrid coupler and the stub are connected via a through hole that passes through the ground conductor, and a distance between conductors that form a transmission line on the ferroelectric transmission line layer is larger than a distance between conductors that form a transmission line on the paraelectric transmission line layer.

Therefore, it is possible to obtain a low-cost phase shifter that provides an effective phase shift amount as well as is manufactured in few processes, and consequently a phased-array antenna can be manufactured in few processes, whereby the manufacturing cost of the phased-array antenna can be reduced.

According to Claim 4 of the present invention, there is provided a phased-array antenna that includes, on a dielectric substrate: plural antenna elements; and an antenna control unit having a feeding terminal to which a high-frequency power is applied, and phase shifters that are connected with the respective antenna elements by feeding lines which branch off from the feeding terminal and electrically change a phase of a high-frequency signal that passes through between the respective antenna elements and the feeding terminal, this phase shifters being placed at some positions on the feeding lines, in which this phase shifter includes: a hybrid coupler on a paraelectric transmission line layer that employs a paraelectric material as a base material; and a stub on a ferroelectric transmission line layer that employs a ferroelectric material as a base material, the paraelectric transmission line layer and the ferroelectric transmission line layer are laminated through a ground conductor, and the hybrid coupler and the stub are electromagnetically connected via a coupling window that is formed in the ground conductor, and a distance between conductors that form a transmission line on the ferroelectric transmission line layer is larger than a distance between conductors that form a transmission line on the paraelectric transmission line layer.

Therefore, it is possible to obtain a low-cost phase shifter that provides a more effective phase shift amount as well as is manufactured in fewer manufacturing processes, and consequently a phased-array antenna can be manufactured in few processes, whereby the manufacturing cost of the phased-array antenna can be reduced.

According to Claim 5 of the present invention, there is provided an antenna control unit including: a feeding terminal to which a high-frequency power is applied; a feeding line that branches off into m lines at a k-th stage branch from the feeding terminal when m=2ˆk (k-th power of 2) (m, k is an integer); m antenna terminals for connecting antenna elements, which are provided on ends of the m feeding lines and arranged in a row, said antenna terminals being referred to as first, second, . . . , and m-th antenna terminals, respectively; Mₖ phase shifters (Mₖ=M₍ₖ₋1)×2+2ˆ(k−1) when k≧1 and M₁=1) which all have the same characteristics and electrically change a phase of a high-frequency signal that passes through the feeding line; and Mₖ loss elements which all have the same characteristics and have a transmission loss amount that is equal to a transmission loss amount of the phase shifter, in which the phase shifters are placed at some positions on the feeding line that branches off into m lines, such that the number of phase shifters which are located between a (n+1)-th antenna terminal (n is an integer that is from 1 to m−1) and the feeding terminal is one larger than the number of phase shifters which are located between an n-th antenna terminal and the feeding terminal, and the loss elements are placed at some positions on the feeding line that branches off into m lines, such that the transmission loss amount from the n-th antenna terminal to the feeding terminal is larger than the transmission loss amount from the (n+1)-th antenna terminal to the feeding terminal, by a transmission loss amount corresponding to one phase shifter.

Therefore, variation in the amounts of distributed power to the m antenna terminals is avoided, whereby deformation of the beam shape or reduction in the amount of changes in the beam direction can be avoided. Consequently, an antenna control unit that has a pointed beam (large directivity gain) and a satisfactory beam tilt amount can be realized.

According to Claim 6 of the present invention, there is provided an antenna control unit including: a feeding terminal to which a high-frequency power is applied; a feeding line that branches off into m lines at a k-th stage branch from the feeding terminal when m=2ˆk (k-th power of 2) (m, k is an integer); m antenna terminals for connecting antenna elements, which are provided on ends of the m feeding lines and arranged in a row, said antenna terminals being referred to as first, second, . . . , and m-th antenna terminals, respectively; Mₖ positive beam tilting phase shifters (Mₖ=M₍ₖ₋1)×2+2ˆ(k−1) when k≧1 and M₁=1) which all have the same characteristics and electrically change a phase of a high-frequency signal that passes through the feeding line in a positive direction; and Mₖ negative beam tilting phase shifters which all have the same characteristics and electrically change the phase of the high-frequency signal that passes through the feeding line in a negative direction, in which the positive beam tilting phase shifters are placed at some positions on the feeding line that branches off into m lines, such that the number of the positive beam tilting phase shifters which are located between an (n+1)-th antenna terminal (n is an integer from 1 to m−1) and the feeding terminal is one larger than the number of the positive beam tilting phase shifters which are located between an n-th antenna terminal to the feeding terminal, and the negative beam tilting phase shifters are placed at some positions on the feeding line that branches off into m lines, such that the number of negative beam tilting phase shifters which are located between an n-th antenna terminal to the feeding terminal is one larger than the number of negative beam tilting phase shifters which are located between an (n+1)-th antenna terminal to the feeding terminal.

Therefore, variation in the amounts of distributed power to the m antenna terminals is avoided, whereby deformation of the beam shape or reduction in the amount of changes in the beam direction can be avoided, and further the reduction in the beam tilt amount can be avoided even when the phase shift amount of the phase shifter is small. Consequently, an antenna control unit that has a more pointed beam (larger directivity gain) and a more satisfactory beam tilt can be realized.

According to Claim 7 of the present invention, there is provided a two-dimensional antenna control unit including: m₂ row antenna control units and one column antenna control unit, this row antenna control unit being the antenna control unit of Claim 5 including m=m₁ antenna terminals (m₁ is an integer), and this column antenna control unit being the antenna control unit of Claim 5 including m=m₂ antenna terminals (m₂ is an integer), in which feeding terminals of the m₂ row antenna control units are connected to the m₂ antenna terminals of the column antenna control unit, respectively.

Therefore, a two-dimensional antenna control unit that has a pointed beam (large directivity gain) as well as a satisfactory beam tilt amount, and can implement X-axial and Y-axial beam tilt can be realized.

According to Claim 8 of the present invention, there is provided a two-dimensional antenna control unit including: m₂ row antenna control units and one column antenna control unit, this row antenna control unit being the antenna control unit of Claim 6 including m=m₁ antenna terminals (m₁ is an integer), and this column antenna control unit being the antenna control unit of Claim 6 including m=m₂ antenna terminals (m₂ is an integer), in which feeding terminals of the m₂ row antenna control units are connected to the m₂ antenna terminals of the column antenna control unit, respectively.

Therefore, a two-dimensional antenna control unit that has a more pointed beam (larger directivity gain) and a more satisfactory beam tilt, as well as can implement the X-axial and Y-axial beam tilt can be realized.

According to Claim 9 of the present invention, in the phased-array antenna of Claim 3, the antenna control unit is the antenna control unit of Claim 5 or 6.

Therefore, a two-dimensional antenna control unit that has a pointed beam (large directivity gain) as well as a satisfactory beam tilt amount can be manufactured in few processes, thereby reducing the manufacturing cost.

According to Claim 10 of the present invention, in the phased-array antenna of Claim 3, the antenna control unit is the antenna control unit of Claim 7 or 8.

Therefore, a phased-array antenna that has a pointed beam (large directivity gain) as well as a satisfactory beam tilt amount, and can implement X-axial and Y-axial beam tilt can be manufactured in few processes, thereby reducing the manufacturing cost.

According to Claim 11 of the present invention, in the phased-array antenna of Claim 4, the antenna control unit is the antenna control unit of Claim 5 or 6.

Therefore, a phased-array antenna that has a more pointed beam (larger directivity gain) as well as a more satisfactory beam tilt amount can be manufactured in few processes, thereby reducing the manufacturing cost.

According to Claim 12 of the present invention, in the phased-array antenna of Claim 4, the antenna control unit is the antenna control unit of Claim 7 or 8.

Therefore, a phased-array antenna that has a more pointed beam (larger directivity gain) as well as a more satisfactory beam tilt amount and can implement X-axial and Y-axial beam tile can be manufactured in fewer processes, thereby reducing the manufacturing cost.

### BRIEF DESCRIPTION OF THE DRAWINGS

FIGS. 1 are a perspective view (FIG. 1(a)) and a cross-sectional view (FIG. 1(b)) illustrating a construction of a phase shifter according to a first embodiment of the present invention, which is employed for a phased-array antenna.

FIGS. 2 are a perspective view (FIG. 2(a)) and a cross-sectional view (FIG. 2(b)) illustrating a construction of a phase shifter according to a second embodiment of the present invention, which is employed for a phased-array antenna.

FIGS. 3 are a diagram illustrating a construction of a phased-array antenna according to a third embodiment of the present invention (FIG. 3(a)), and a diagram showing directivities of this phased-array antenna (FIG. 3(b)).

FIGS. 4 are a diagram illustrating a construction of a phased-array antenna according to a fourth embodiment of the present invention (FIG. 4(a)), and a diagram showing directivities of this phased-array antenna (FIG. 4(b)).

FIG. 5 is a diagram illustrating a construction of a phased-array antenna according to a fifth embodiment of the present invention.

FIG. 6 is a diagram illustrating a construction of a phased-array antenna according to a sixth embodiment of the present invention.

FIG. 7 is a table showing the relationship of the number of branch stages (k), the number of antenna elements (m), and the number of phase shifters (Mₖ) in the antenna control unit or phased-array antenna according to the sixth embodiment.

FIGS. 8 are diagrams showing placements of phase shifters when k=1 and m=2 (FIG. 8(a)), when k=2 and m=4 (FIG. 8(b)), and when k=3 and m=8 (FIG. 8(c)).

FIGS. 9 are a diagram illustrating a construction of a phase shifter that is employed for a conventional phased-array antenna (FIG. 9(a)), and a diagram showing permittivity changing characteristics of a ferroelectric material (FIG. 9(b)).

FIGS. 10 are a diagram showing a construction and operating principles of the conventional phased-array antenna (FIG. 10(a)), and a diagram showing directivities of the conventional phased-array antenna (FIG. 10(b)).

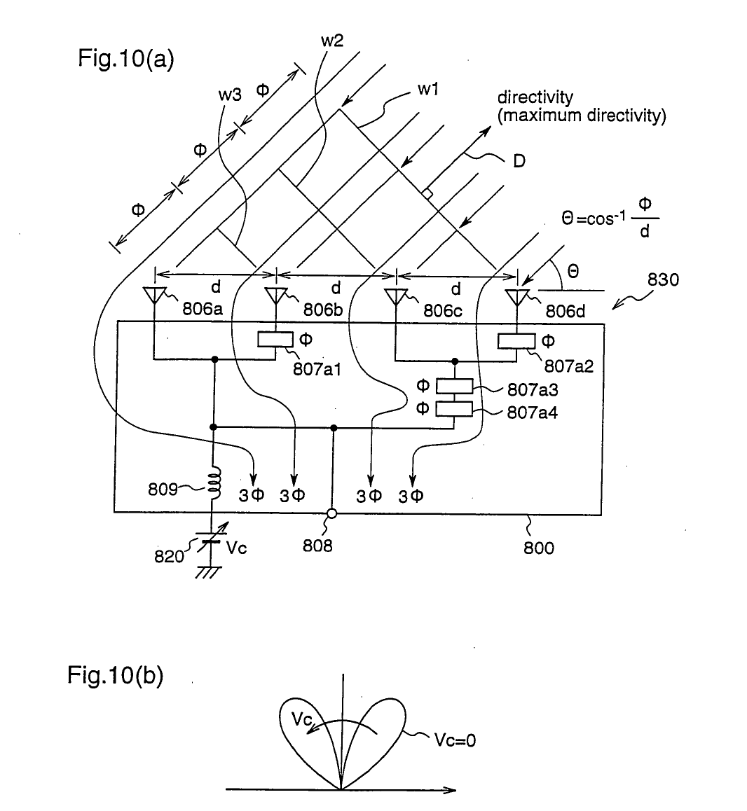

### BEST MODE FOR CARRYING OUT THE INVENTION

### Embodiment 1

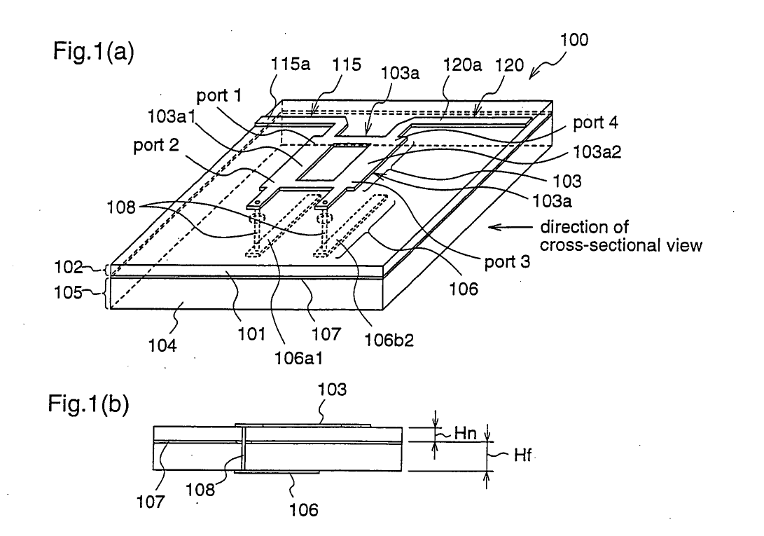

Hereinafter, a first embodiment of the present invention will be described with reference to FIG. 1.

In the first embodiment, a phase shifter that is employed for a phased-array antenna of the present invention will be described.

FIGS. 1 are a perspective view (FIG. 1(a)) and a cross-sectional view (FIG. 1(b)) illustrating a construction of the phase shifter according to the first embodiment, which is employed for the phased-array antenna of the present invention.

In FIGS. 1, reference numeral 100 denotes a phase shifter. Numeral 101 denotes a paraelectric base material, numeral 102 denotes a paraelectric transmission line layer, numeral 103 denotes a microstrip hybrid coupler, numeral 104 denotes a ferroelectric base material, numeral 105 denotes a ferroelectric transmission line layer, numeral 106 denotes a microstrip stub, numeral 107 denotes a ground conductor, and numeral 108 denotes a through hole by which the microstrip hybrid coupler 103 and the microstrip stub 106 are connected through the ground conductor 107.

Initially, a feature of the phase shifter 100 according to the first embodiment, which is superior to the conventional phase shifter 700, will be described in detail.

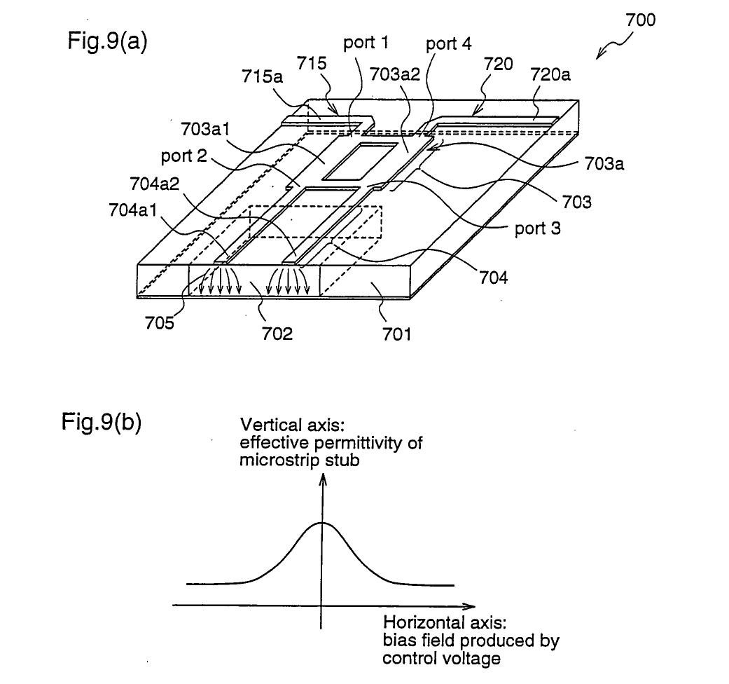

As mentioned above, in the phase shifter 700 shown in FIG. 9(a), the distributed capacitance Cn per unit length of the line for the microstrip hybrid coupler 703 and the distributed capacitance Cf per unit length of the line for the microstrip stub 704 are greatly different, and accordingly the power from the microstrip hybrid coupler 703 does not enter the microstrip stub 704 so efficiently, whereby a sufficient phase shift amount cannot be obtained. To overcome this problem, when a magnetic material is added to the microstrip stub 704 of the phase shifter 700 to increase the distributed inductance L per unit length of the line as shown in Prior Art 1, the construction of the conventional phase shifter 700 that is formed in one piece by allocating areas on the same plane to the ferroelectric base material 702 and the paraelectric base material 701 respectively requires much more processes, whereby the manufacturing cost is adversely increased.

Thus, in the phase shifter 100 of the first embodiment, as shown in FIG. 1(a), the microstrip hybrid coupler 103 is formed on the paraelectric transmission line layer 102 that employs a paraelectric material for the base material 101, the microstrip stub 106 is formed on the ferroelectric transmission line layer 105 that employs a ferroelectric material for the base material 104, these two transmission line layers 102 and 105 are laminated through the ground conductor 107, and then the microstrip hybrid coupler 103 and the microstrip stub 106 are connected via through holes 108 which pass through the ground conductor 107. Further, as shown in FIG. 1(b), the distance Hf between conductors that constitute the transmission line of the ferroelectric conductor line layer 103 is larger than the distance Hn between conductors that constitute the transmission line of the paraelectric transmission line layer 102. Accordingly, the line impedances Z of the microstrip hybrid coupler 103 and the microstrip stub 106 can be matched, whereby the phase shifter 100 providing an effective phase shift amount can be manufactured in simpler manufacturing processes.

A detailed explanation of the phase shifter will be given hereinafter. For example, assuming that the permittivity of the paraelectric base material 101 as the base material for the microstrip hybrid coupler 103 is εn, and the permittivity of the ferroelectric base material 104 as the base material for the microstrip stub 106 is εf, the distributed capacitance Cn per unit length of the line for the microstrip hybrid coupler 103 is given by an expression Cn=εn·W/Hn, and the distributed capacitance Cf per unit length of the line for the microstrip stub 106 is given by an expression Cf=εf·W/Hf. When Cn and Cf are compared with each other, the relationship εn<<εf is established as described above, but the relationship Hn<Hf is established as shown in FIG. 1(b), so that the difference between the distributed capacitance Cn per unit length of the line for the microstrip hybrid coupler 103 and the distributed capacitance Cf per unit length of the line for the microstrip stub 106 gets smaller. Consequently, the reduction in the matching degree between the line impedances Z of the microstrip hybrid coupler 103 and the microstrip stub 106 can be avoided, so that the power from the microstrip hybrid coupler 103 enters the microstrip stub 106 efficiently, whereby a sufficient phase shift amount can be obtained.

Hereinafter, the operating principles of the phase shifter according to the first embodiment will be described.

In the phase shifter 100, the microstrip hybrid coupler 103 using the paraelectric base material 101, the ground conductor 107, and the microstrip stub 106 using the ferroelectric base material 104 are laminated, and the microstrip hybrid coupler 103 and the microstrip stub 106 are connected via through holes 108 that pass through the ground conductor 107. This phase shifter 100 is constituted such that the phase shift amount of a high-frequency power that passes through the microstrip hybrid coupler 103 varies according to a DC control voltage that is applied to the microstrip stub 106.

In other words, the base material of the phase shifter 100 is composed of the paraelectric base material 101, the ground conductor 107, and the ferroelectric base material 104. A rectangular loop-shaped conductor layer 103a is disposed on the paraelectric base material 101, and this loop-shaped conductor layer 103a and the paraelectric base material 101 form the microstrip hybrid coupler 103.

Under the ferroelectric base material 104, two linear conductor layers 106a1 and 106a2 are placed so as to be linked to one end of the two opposed linear portions 103a1 and 103a2 of the rectangular loop-shaped conductor layer 103a via the through holes 108, respectively. These two linear conductor layers 106a1 and 106a2 and the ferroelectric base material 104 form the microstrip stub 106.

On the paraelectric base material 101, conductor layers 115a and 120a are disposed so as to be located on extension lines of the two linear portions 103a1 and 103a2, and linked to the other ends of the two linear portions 103a1 and 103a2, respectively.

This conductor layer 115a and the paraelectric base material 101 form an input line 115, and the conductor layer 120a and the paraelectric base material 101 form an output line 120. Here, the one end and the other end of the linear portion 103a1 of the loop-shaped conductor layer 103a are ports 2 and 1 of the microstrip hybrid coupler 103, respectively, and the one end and the other end of the linear portion 103a2 of the loop-shaped conductor layer 103a are ports 3 and 4 of the microstrip hybrid coupler 103, respectively.

In the phase shifter 100 having the above-mentioned construction, when a DC control voltage is applied to the microstrip stub 106, the amount of phase shift of a high-frequency power that passes therethrough varies.

Hereinafter, a detailed explanation will be given. In the phase shifter 100 having such a construction that the same reflection element (microstrip stub 106) is connected to two adjacent ports (ports 2 and 3) of the properly-designed microstrip hybrid coupler 103 via the through holes 108, a high-frequency power that has entered from the input port (port 1) is not outputted through this input port 1, but a high-frequency power on which a reflected power from the reflection element has been reflected is outputted only through the output port (port 4). Then, a bias field is produced when the control voltage is applied to the microstrip stub 106, and an effective permittivity of the microstrip stub 106 for the high-frequency power varies when the control voltage is changed. Accordingly, an equivalent power length of the microstrip stub 106 for the high-frequency power varies, and the phase of the microstrip stub 106 varies according to changes in the equivalent power length, whereby the phase of a high-frequency power that is outputted through the output port (port 4) varies.

As described above, the phase shifter 100 according to the first embodiment is constituted by laminating planar sheet-type materials, i.e., the paraelectric base material 101, the ground conductor 107 and the ferroelectric base material 104, and forming the through holes 108 that pass through the ground conductor 107, whereby the microstrip hybrid coupler 103 that is formed on the paraelectric transmission line layer 102 and the microstrip stub 106 that is formed on the ferroelectric transmission line layer 105 are connected each other, and in this phase shifter, the thickness Hf of the base material of the ferroelectric transmission line layer 105 that is provided with the microstrip stub 106 is larger than the thickness Hn of the base material of the paraelectric transmission line layer 102 that is provided with the microstrip hybrid coupler 103. Therefore, the deterioration in the line impedance matching between the microstrip hybrid coupler 103 and the microstrip stub 106 is suppressed, whereby a phase shifter that provides an effective phase shift amount can be obtained. Further, this phase shifter can be manufactured in fewer manufacturing processes as compared to the method by which the base materials are disposed with allocating areas on the same plane to the respective base materials, like in the conventional phase shifter 700, and thus the phase shifter can be produced at a lower cost.

Further, when this phase shifter 100 is employed for a phased-array antenna, the phased-array antenna can be manufactured in fewer processes, thereby reducing the manufacturing cost.

### Embodiment 2

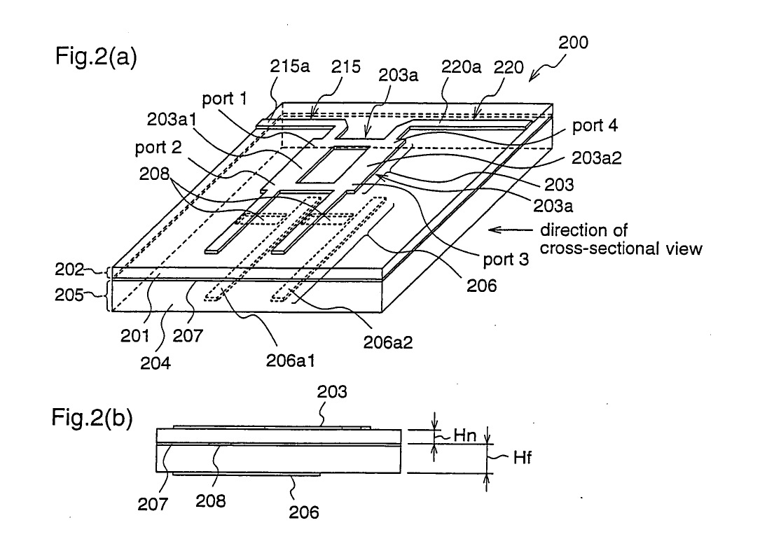

A second embodiment of the present invention will be described with reference to FIGS. 2.

In this second embodiment, a phase shifter that is employed for a phased-array antenna of the present invention will be described.

FIGS. 2 are a perspective view (FIG. 2(a)) and a cross-sectional view (FIG. 2(b)) illustrating a construction of the phase shifter according to the second embodiment, which is employed for the phased-array antenna of the present invention.

In FIGS. 2, reference numeral 200 denotes a phase shifter. Numeral 201 denotes a paraelectric base material, numeral 202 denotes a paraelectric transmission line layer, numeral 203 denotes a microstrip hybrid coupler, numeral 204 denotes a ferroelectric base material, numeral 205 denotes a ferroelectric transmission line layer, numeral 206 denotes a microstrip stub, numeral 207 denotes a ground conductor, and numeral 208 denotes a coupling window that is formed in the ground conductor 207, for electromagnetically coupling the microstrip hybrid coupler 203 and the microstrip stub 206.

Initially, a feature of the phase shifter 200 according to the second embodiment, which is superior to the conventional phase shifter 700, will be described in detail.

As described in the first embodiment, when a magnetic material is added to the microstrip stub 704 of the conventional phase shifter 700 shown in FIG. 9(a) to increase the distributed inductance L per unit length of the line as shown in Prior Art 1, so as to solve the problem that a sufficient amount of phase shift for the conventional phase shifter 700 is not obtained, the conventional phase shifter 700 that is formed in one piece by allocating areas on the same plane to the ferroelectric base material 702 and the paraelectric base material 701, respectively, needs much more processes, whereby the manufacturing cost is increased.

In the phase shifter 200 according to the second embodiment as shown in FIG. 2(a), the microstrip hybrid coupler 203 is formed on the paraelectric transmission line layer 202 that uses a paraelectric material for the base material 201, and the microstrip stub 206 is formed on the ferroelectric transmission line layer 205 that uses a ferroelectric material for the base material 204, then these two transmission line layers 202 and 205 are laminated through the ground conductor 207, and the microstrip hybrid coupler 203 and the microstrip stub 206 are electromagnetically connected via the coupling window 208 that is formed in the ground conductor 207, and further, as shown in FIG. 2(b), the distance Hf between conductors that form the transmission line on the ferroelectric transmission line layer 205 is larger than the distance Hn between conductors that form the transmission line on the paraelectric transmission line layer 202. Accordingly, the line impedances Z of the microstrip hybrid coupler 203 and the microstrip stub 206 can be matched, whereby the phase shifter 200 providing an effective phase shift amount can be manufactured in simpler manufacturing processes.

Hereinafter, a detailed explanation will be given. For example, assuming that the permittivity of the paraelectric base material 201 as the base material of the microstrip hybrid coupler 203 is εn and the permittivity of the ferroelectric base material 204 as the base material of the microstrip stub 206 is εf, the distributed capacitance Cn per unit length of the line for the microstrip hybrid coupler 203 is given by an expression Cn=εn·W/Hn, and the distributed capacitance Cf per unit length of the line for the microstrip stub 206 is given by an expression Cf=εf·W/Hf. When Cn and Cf are compared with each other, εn<<εf but in this second embodiment Hn<Hf as shown in FIG. 2(b), so that the difference between the distributed capacitance Cn per unit length of the line for the microstrip hybrid coupler 203 and the distributed capacitance Cf per unit length of the line for the microstrip stub 206 gets smaller. Consequently, the deterioration of the matching between the line impedances Z of the microstrip hybrid coupler 203 and the microstrip stub 206 can be avoided, whereby the power from the microstrip hybrid coupler 203 enters the microstrip stub 206 efficiently, and a sufficient phase shift amount can be obtained.

Hereinafter, the operating principles of the phase shifter according to the second embodiment will be described.

In this phase shifter 200, the microstrip hybrid coupler 203 using the paraelectric base material 201, the ground conductor 207, and the microstrip stub 206 using the ferroelectric base material 204 are laminated, and the microstrip hybrid coupler 203 and the microstrip stub 206 are electromagnetically connected via the coupling window 208 that is formed in the ground conductor 207. This phase shifter is constituted so that the amount of phase shift of the high-frequency power that passes through the microstrip hybrid coupler 203 varies according to a DC control voltage that is applied to the microstrip stub 206.

In other words, the base material of the phase shifter 200 is composed of the paraelectric base material 201, the ground conductor 207, and the ferroelectric base material 204. A rectangular loop-shaped conductor layer 203a is disposed on the paraelectric base material 201, and this loop-shaped conductor layer 203a and the paraelectric base material 201 form the microstrip hybrid coupler 203.

Two linear conductor layers 206a1 and 206a2 are disposed under the ferroelectric base material 204 so as to be electromagnetically connected to one end of the two opposed linear portions 203a1 and 203a2 of the rectangular loop-shaped conductor layer 203a, respectively, via the coupling window 208. These two linear conductor layers 206a1 and 206a2 and the ferroelectric base material 204 form the microstrip stub 206.

Further, conductor layers 215a and 220a are disposed on the paraelectric base material 201 so as to be located on extension lines of the two linear portions 203a1 and 203a2 and linked to the other ends of the two linear portions 203a1 and 203a2, respectively.

This conductor layer 215a and the paraelectric base material 201 form an input line 215, and the conductor layer 220a and the paraelectric base material 201 form an output line 220. Here, the one end and the other end of the linear portion 203a1 of the loop-shaped conductor layer 203a are ports 2 and 1 of the microstrip hybrid coupler 203, and the one end and the other end of the linear portion 203a2 of the loop-shaped conductor layer 203a are ports 3 and 4 of the microstrip hybrid coupler 203, respectively.

In the phase shifter having the above-mentioned construction, when a DC control voltage is applied to the microstrip stub 206, the amount of phase shift of the high-frequency power that passes therethrough varies.

Hereinafter, a detailed explanation will be given. In the phase shifter 200 in which the same reflection element (microstrip stub 206) is electromagnetically connected to two adjacent ports (ports 2 and 3) of the properly-designed microstrip hybrid coupler 203 via the coupling window 208, a high-frequency power that has entered from the input port (port 1) is not outputted from this input port 1, and a high-frequency power upon which a reflected power from the reflection element has been reflected is outputted only through the output port (port 4). Then, a bias field is produced when a control voltage is applied to the microstrip stub 206, and the effective permittivity of the microstrip stub 206 for the high-frequency power varies when this control voltage is changed. Accordingly, the equivalent electrical length of the microstrip stub 206 for the high-frequency power varies, whereby the phase of the high-frequency power that is outputted from the output port (port 4) varies.

As described above, according to the second embodiment, the phase shifter 200 is constituted by laminating planar sheet-type materials, i.e., the paraelectric base material 201, the ground conductor 207 comprising the coupling window 208, and the ferroelectric base material 204, in which the thickness Hf of the base material for the ferroelectric transmission line layer 205 that is provided with the microstrip stub 206 is larger than the thickness Hn of the base material for the paraelectric transmission line layer 202 that is provided with the microstrip hybrid coupler 203. Therefore, the deterioration of the line impedance matching between the microstrip hybrid coupler 203 and the microstrip stub 206 can be avoided, whereby a phase shifter providing an effective phase shift amount can be obtained. Further, this phase shifter can be manufactured in fewer manufacturing processes as compared to the method by which the base materials are disposed such that areas on one plane are allocated to the respective base materials like in the conventional phase shifter 700, whereby the phase shifter can be produced with a lower cost.

Further, when the phase shifter 200 is employed for a phased-array antenna, the phased-array antenna can be manufactured in fewer processes, thereby reducing the manufacturing cost.

### Embodiment 3

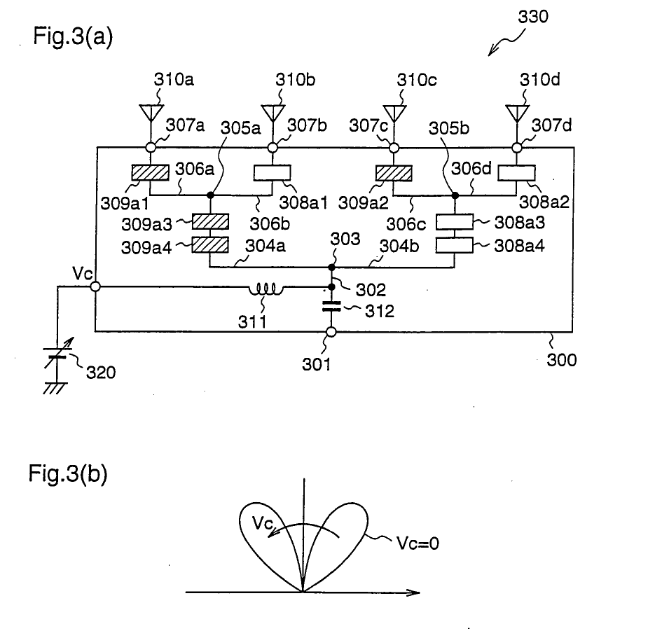

A third embodiment of the present invention will be described with reference to FIGS. 3.

FIG. 3(a) is a diagram illustrating a construction of a phased-array antenna according to the third embodiment, and FIG. 3(b) is a diagram showing directivities of the phased-array antenna according to the third embodiment in a case where a beam tilt voltage is applied and a case where a beam tilt voltage is not applied.

In FIG. 3(a), a phased-array antenna 330 according to the third embodiment comprises an antenna control unit 300, a beam tilt voltage 320 for performing control of the directivity (beam tilt) as shown in FIG. 3(b), and four antenna elements 310a-310d. The antenna control unit 300 comprises an input terminal (feeding terminal) 301, four antenna terminals 307a-307d, four phase shifters 308a1-304a4, four loss elements 309a1-309a4, high frequency blocking element 311, a DC blocking element 312, a transmission line (feeding line) 302 from the input terminal 301, two transmission lines 304a and 304b that branch off at a first branch 303, and four transmission lines 306a-306d that branch off from the transmission lines 304a and 304b at second branches 305a and 305b.

Hereinafter, the construction of the antenna control unit 300 that constitutes the phased-array antenna 330 according to the third embodiment will be described in more detail.

The antenna control unit 300 according to the third embodiment includes one input terminal 301, then the transmission line 302 from the input terminal 301 branches off into two transmission lines 304a and 304b at the first branch 303, and further the two transmission lines 304a and 304b that branch off at the first branch 303 further branch off into two transmission lines at the second branches 305a and 305b, whereby branched four transmission lines 306a-306d are obtained.

Further, the input terminal 301 is connected to the first branch 303 through the blocking element 312, and the beam tilt voltage 320 is connected to the first branch 303 through the high frequency blocking element 311.

The four transmission lines 306a-306d are provided with four antenna terminals 307a-307d for connection of four antenna elements 310a-310d.

When the four antenna terminals 307a-307d are arranged in a row, which are referred to as first, second, third, and fourth antenna terminals, respectively, and when it is assumed that n is an integer that satisfies 0<n<4, the phase shifters 308a1-308a4 are arranged so that the number of phase shifters 308a which are located between the (n+1)-th antenna terminal 307 and the input terminal 301 is one larger than the number of phase shifters 308a which are located between the n-th antenna terminal 307 and the input terminal 301. Here, the respective phase shifters 308a1-308a4 have the same characteristics.

Further, in the antenna control unit 300 according to the third embodiment, the loss elements 309a1-309a4 each having a transmission loss that is equal to a transmission loss amount corresponding to one phase shifter 308a are placed so that the number of loss elements 309a which are located between the n-th antenna terminal 307 and the input terminal 301 is one larger than the number of loss elements 309a which are located between the (n+1)-th antenna terminal 307 and the input terminal 301. Therefore, the transmission loss amounts from all the antenna terminals 307a-307d to the input terminal 301 are of the same value.

In common phased-array antennas, when the transmission loss amounts from the respective antenna elements 310a-310d to the input terminal 301 as a power composition point are different from each other, the power compositing effect is reduced, whereby the shape of the beam as shown in FIG. 3(b) is deformed and it becomes difficult to obtain a pointed beam (large directivity gain), as well as the beam tilt amount is reduced, and accordingly the control of the antenna's directivity is deteriorated.

However, in the antenna control unit 300 according to the third embodiment, the loss elements 309a are placed so that the amount of transmission loss which occurs from the n-th antenna terminal 307 (n is an integer that satisfies 0<n<4) to the input terminal 301 is larger than the transmission loss amount from the (n+1)-th antenna terminal 307 to the input terminal 301, by an amount as much as the transmission loss corresponding to one phase shifter 308a. Therefore, the transmission loss amounts from all the antenna elements 310a-310d to the input terminal 301 are of the same value, whereby a phased-array antenna that has a pointed beam and a satisfactory beam tilt amount can be realized.

As described above, according to the third embodiment, when n is an integer that satisfies 0<n<4, the phase shifters 308a are placed such that the number of phase shifters 308a which are located between the (n+1)-th antenna terminal 307 and the input terminal 301 is one larger than the number of phase shifters 308a which are located between the n-th antenna terminal 307 and the input terminal 301, and further the loss elements 309a are placed such that the transmission loss amount from the n-th antenna terminal 307 to the input terminal 301 is larger than the transmission loss amount from the (n+1)-th antenna terminal 307 to the input terminal 301, by an amount as much as the transmission loss corresponding to one phase shifter 308a. Therefore, even when any passage loss is generated in the phase shifters 308a1-304a4, the amounts of distributed power for the respective antenna elements 310a-310d are not different from each other, and consequently, the antenna control unit 300 by which the beam shape is not deformed or the changes in the beam direction are not reduced can be obtained. Further, when this antenna control unit 300 is employed for a phased-array antenna, the transmission loss amounts from all of the antenna elements 310a-310d to the input terminal 301 can be made equal, whereby a phased-array antenna that has a pointed beam and a satisfactory beam tilt amount can be realized.

Further, when the phase shifter as described in the first or second embodiment is employed for the phased-array antenna according to the third embodiment, the manufacturing cost of the phased-array antenna can be further reduced.

### Embodiment 4

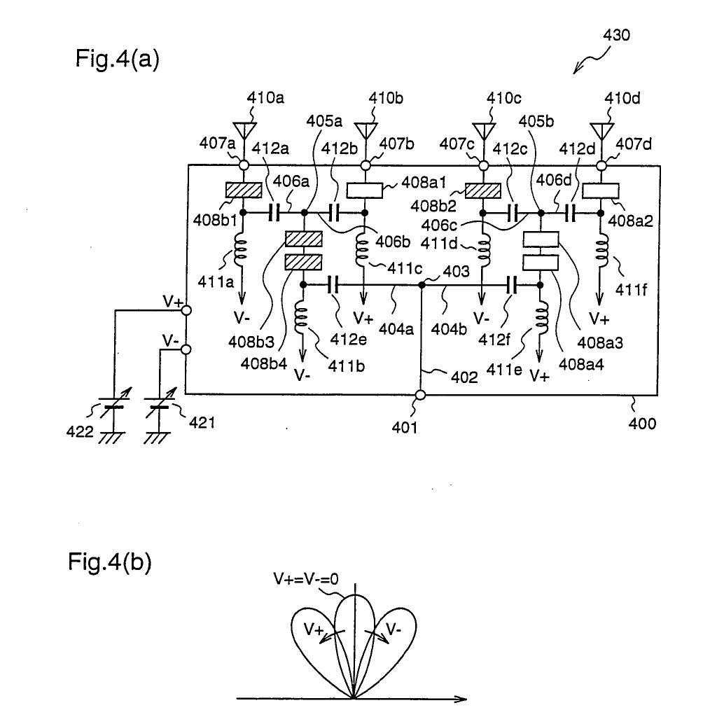

A fourth embodiment will be described with reference to FIGS. 4.

In this fourth embodiment, an antenna control unit in a phased-array antenna, which has a different construction from that of the third embodiment will be described in detail.

FIG. 4(a) is a diagram illustrating a construction of a phased-array antenna according to the fourth embodiment, and FIG. 4(b) is a diagram showing directivities of the phased-array antenna according to the fourth embodiment in a case where a beam tilt voltage is applied and a case where the beam tilt voltage is not applied.

In FIG. 4(a), a phased-array antenna 430 according to the fourth embodiment comprises an antenna control unit 400, negative and positive beam tilt voltages 421 and 422 that perform control on negative and positive directivities (beam tilt), respectively, as shown in FIG. 4(b), and four antenna elements 410a-410d. The antenna control unit 400 comprises an input terminal 401, four antenna terminals 407a-407d, four positive beam tilting phase shifters 408a1-404a4, four negative beam tilting phase shifters 408b1-408b4, high frequency blocking elements 411a-411f, DC blocking elements 412a-412f, a transmission line 402 from the input terminal 401, two transmission lines 404a and 404b that branch off at a first branch 403, and four transmission lines 406a-406d that branch off from the transmission lines 404a and 404b at second branches 405a and 405b.

Hereinafter, the antenna control unit 400 that constitutes the phased-array antenna 430 according to the fourth embodiment will be described in more detail.

The antenna control unit 400 of the fourth embodiment includes one input terminal 401, and then the transmission line 402 from the input terminal 410 branches off into the two transmission lines 404a and 404b at the first branch 403, and further the two transmission lines 404a and 404b that branch off at the first branch 403 branch off into two transmission lines at the second branches 405a and 405b, respectively, thereby resulting in four transmission lines 406a-406d.

Each of the two transmission lines 404a and 404b that branch off at the first branch 403 is provided with one DC blocking element 412, and further each of the four transmission lines 406a-406d that branch off at the second branches 405a and 405b, respectively, is provided with one DC blocking element 412. A high frequency block element 411 is placed on one end of the respective negative beam tilting phase shifters 408b1, 408b4, and, 408b2, and on one end of the respective positive beam tilting phase shifters 408a1, 404a4, and 408a2.

The four transmission lines 406a-406d are provided with four antenna terminals 407a-407d, respectively, so as to be connected to four antenna elements 410a-410d.

These four antenna terminals 407a-407d, which are referred to as first, second, third, and fourth antenna terminals, respectively, are arranged in a row, and when assuming that n is an integer that satisfies 0<n<4, the positive beam tilting phase shifters 408a1-408a4 are placed so that the number of phase shifters which are located from the (n+1)-th antenna terminal 407 to the input terminal 401 is one larger than the number of phase shifters which are located from the n-th antenna terminal 407 to the input terminal 401.

Further, the negative beam tilting phase shifters 408b1-408b4 are placed so that the number of phase shifters which are located between the n-th antenna terminal 407 and the input terminal 401 is one larger than the number of phase shifters which are located between the (n+1)-th antenna terminal 407 and the input terminal 401.

Here, the positive beam tilting phase shifters 408a1-408a4 and negative beam tilting phase shifters 408b1-408b4 all have the same characteristics (same transmission loss amount).

Therefore, in the antenna control unit 400 having the above-mentioned construction, the transmission loss amounts from all the antenna terminals 407a-407d to the input terminal 401 are the same.

In common phased-array antennas, when the transmission loss amounts from the respective antenna elements 410a-410d to the input terminal 401 as the electric power composition point are different from each other, the electric power composition effect is reduced, whereby the shape of beam as shown in FIG. 4(b) is deformed, and thus it is difficult to obtain a pointed beam (large directivity gain), as well as the beam tilt amount is reduced, and accordingly the control on the antenna's directivity is deteriorated.

Further, in a phased-array antenna that uses the ferroelectric material for the phase shifter 408, when the rate of change in the permittivity of the ferroelectric material is small, a phase shift amount that can be realized by one phase shifter 408 is small, so that it is quite difficult to obtain a phased-array antenna having a large amount of beam tilt.

However, in this antenna control unit 400 according to the fourth embodiment, the transmission loss amounts from all the antenna elements 410a-410d to the input terminal 401 are the same, and further the positive beam tilting phase shifters 408a and the negative beam tilting phase shifters 408b are provided. Therefore, each of the phase shifters 408 takes charge of only a smaller phase shift amount, whereby a phased-array antenna having a more pointed beam and a more satisfactory beam tilt amount can be realized.

As described above, according to the fourth embodiment, when n is an integer that satisfies 0<n<4, the positive beam tilting phase shifters 408a1-408a4 are placed so that the number of positive beam tilting phase shifters 408a which are located between the (n+1)-th antenna terminal 407 and the input terminal 401 is one larger than the number of positive beam tilting phase shifters 408a which are located between the n-th antenna terminal 407 and the input terminal 401, and further the negative beam tilting phase shifters 408b1-408b4 are placed so that the number of negative beam tilting phase shifters 408b which are located between the n-th antenna terminal 407 and the input terminal 401 is one larger than the number of negative beam tilting phase shifters 408b which are located between the (n+1)-th antenna terminal 407 and the input terminal 401. Therefore, each of the phase shifters 408 takes charge of only a smaller phase shift amount, and consequently, an antenna control unit 400 which does not reduce the beam tilt amount even when the permittivity change rate for the ferroelectric material of each phase shifter 408 is low can be obtained. Further, when the antenna control unit 400 is employed, the transmission loss amounts from all the antenna elements 410a-410d to the input terminal 401 can be equalized, whereby a phased-array antenna that has a more pointed beam and a more satisfactory beam tilt amount can be realized.

Further, when the phase shifter as described in the first or second embodiment is employed for the phased-array antenna according to the fourth embodiment, the manufacturing cost of the phased-array antenna can be further reduced.

### Embodiment 5

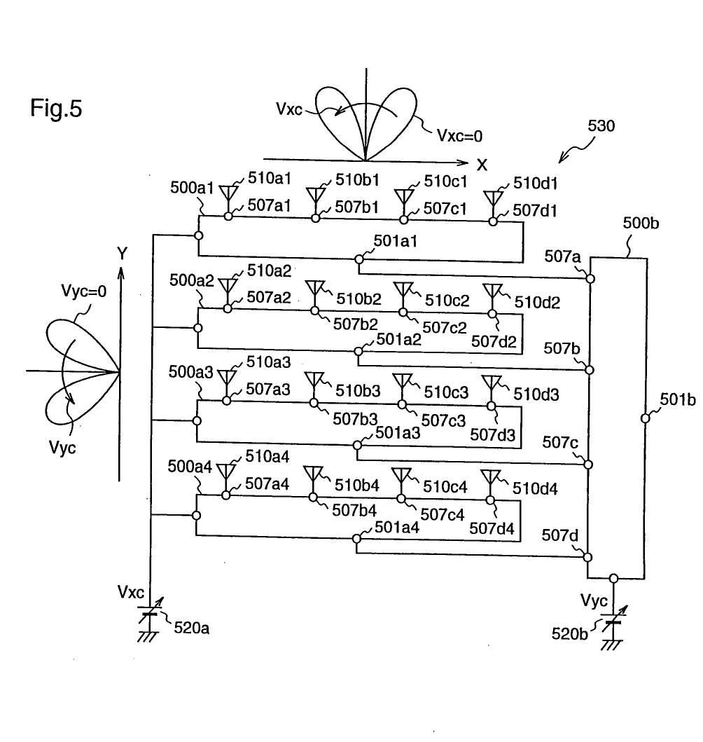

A fifth embodiment of the present invention will be described with reference to FIG. 5.

In this fifth embodiment, a description will be given of a phased-array antenna comprising a two-dimensional antenna control unit that is obtained by combining a plurality of the antenna control units that have been described in the third embodiment, and can control the directivity in the X-axis direction and the Y-axis direction.

FIG. 5 is a diagram illustrating a construction of a phased-array antenna according to the fifth embodiment.

In FIG. 5, a phased-array antenna 530 according to the fifth embodiment comprises antenna elements 510a(1-4)-510d(1-4), X-axial antenna control units 500a1-500a4 that perform control of the X-axial directivity (beam tilt), a Y-axial antenna control unit 500b that performs control of the Y-axial directivity, an X-axial beam tilt voltage 520a, and a Y-axial beam tilt voltage 520b. Each of the X-axial antenna control units 500a includes antenna terminals 507a-507d, and an input terminal 501a. The Y-axial antenna control unit 500b includes antenna terminals 507a-507d, and an input terminal 501b. Here, it is assumed that each of the X-axial antenna control units 500a1-500a4 and the Y-axial antenna control unit 500b has the same construction as that of the antenna control unit 300 as described above in detail in the third embodiment.

Hereinafter, the phased-array antenna 530 according to this embodiment will be specifically described.

The input terminals 501a1-501a4 of the X-axial antenna control units 500a1-500a4 are connected to the antenna terminals 507a-507d of the Y-axial antenna control unit 500b, respectively. Though not shown here, four phase shifters 308a and four loss elements 309a each having the same transmission loss amount are disposed in each of the X-axial antenna control units 500a1-500a4 and the Y-axial antenna control unit 500b as shown in FIG. 3, as described in the third embodiment.

Therefore, according to the phased-array antenna 530 of the fifth embodiment, the transmission loss amounts from all the antenna terminals 507a-507d to the input terminal 501a in the X-axial antenna control units 500a1-500a4 are of the same value, and further the transmission loss amounts from all the antenna terminals 507a-507d to the input terminal 501b in the Y-axial antenna control unit 500b are of the same value. Accordingly, a phased-array antenna that has a pointed beam (large directivity gain) and a satisfactory beam tilt amount, and can control the X-axial directivity and the Y-axial directivity can be realized.

As described above, the phased-array antenna of the fifth embodiment employs an antenna control unit which includes the X-axial antenna control units 500a1-500a4 that control the X-axial directivity and the Y-axial antenna control unit 500b that controls the Y-axial directivity, and as the X-axial and Y-axial antenna control units 500, an antenna control unit as described in the third embodiment, which is provided with the phase shifters 308a and the loss elements 309a as many as the phase shifters 308a, each loss element having the same transmission loss amount as the phase shifter 308a, whereby the distributed power to the respective antenna elements 510 is equalized also when any passage loss occurs in the phase shifter 308, thereby to prevent the deformation of the beam shape or the reduction in the beam tilt changes. Therefore, a phased-array antenna that has a pointed beam (large directivity gain) and a satisfactory beam tilt amount, as well as can control the X-axial and Y-axial directivities can be realized.

### Embodiment 6

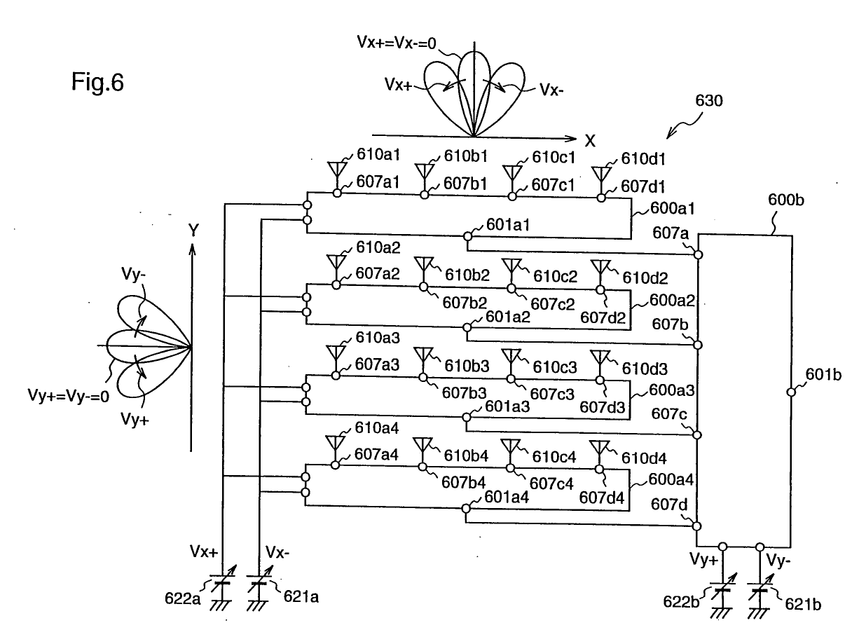

A sixth embodiment of the present invention will be described with reference to FIG. 6.

In this sixth embodiment, a phased-array antenna having a two-dimensional antenna control unit which is obtained by combining a plurality of the antenna control units as described in the fourth embodiment and can control X-axial and Y-axial directivities will be described.

FIG. 6 is a diagram illustrating a construction of a phased-array antenna according to the sixth embodiment.

In FIG. 6, a phased-array antenna 630 of the sixth embodiment includes antenna elements 610a(1-4)-610d(1-4), X-axial antenna control units 600a1-600a4 that perform control of the X-axial directivity (beam tilt), a Y-axial antenna control unit 600b that performs control of the Y-axial directivity, an X-axial negative beam tilt voltage 621a, an X-axial positive beam tilt voltage 622a, a Y-axial negative beam tilt voltage 621b, and a Y-axial positive beam tilt voltage 622b. Further, each of the X-axial antenna control units 600a includes antenna terminals 607a-607d, and an input terminal 601a. The Y-axial antenna control unit 600b includes antenna terminals 607a-607d, and the input terminal 601b. It is assumed here that each of the X-axial antenna control units 600a1-600a4 and the Y-axial antenna control unit 600b has the same construction as that of the antenna control unit 400 that has been specifically described in the fourth embodiment.

Hereinafter, the phased-array antenna 630 according to the sixth embodiment will be described in more detail.

The input terminals 601a1-601a4 of the X-axial antenna control units 600a1-600a4 are connected to the antenna terminals 607a-607d of the Y-axial antenna control unit 600b, respectively. Though not shown here, four positive beam tilting phase shifters 408a and four negative beam tilting phase shifters 408b are included in each of the X-axial antenna control units 600a1-600a4 and the Y-axial antenna control unit 600b, as shown in FIG. 4, as described in the fourth embodiment.

Therefore, according to the phased-array antenna 630 of the sixth embodiment, in each of the X-axial antenna control units 600a1-600a4 and the Y-axial antenna control unit 600b, the transmission loss amounts from all the antenna terminals 607a-607d to the input terminal 601a are of the same value, and each phase shifter takes charge of only a smaller phase shift amount, whereby a phased-array antenna which has a more pointed beam and a more satisfactory beam tilt amount, as well as can control the X-axial and Y-axial directivities can be realized.

As described above, according to the sixth embodiment, the phased-array antenna includes the X-axial antenna control units 600a1-600a4 that control the X-axial directivity, and the Y-axial antenna control unit 600b that controls the Y-axial directivity. Further, as the X-axial and Y-axial antenna control units 600, an antenna control unit is employed in which equal numbers of positive beam tilting phase shifters 408a and negative beam tilting phase shifters 408b each having the same transmission loss amount are disposed as described in the fourth embodiment, and thus each of the phase shifters 408 takes charge of only a smaller phase shift amount even when the permittivity change rate of the ferroelectric material for each phase shifter 408 is low, thereby avoiding the reduction in the beam tilt amount, and further the distributed power to the respective antenna elements 610 are equalized even when the passage loss arises in each phase shifter, whereby the deformation of the beam shape or the reduction of changes in the beam direction can be prevented. Therefore, a phased-array antenna which has a more pointed beam and a more satisfactory beam tilt amount, and can control the X-axial and Y-axial directivities can be realized.

Further, in each of the antenna control units 600 that constitute the phased-array antenna of the sixth embodiment, when the X-axial positive beam tilting phase shifters, the X-axial negative beam tilting phase shifters, the Y-axial positive beam tilting phase shifters, and the Y-axial negative beam tilting phase shifters are disposed on different layers, a more high-density and compact antenna control unit can be realized in addition to the above-mentioned effects.

In the description of any of the above embodiments, the transmission lines that constitute the microstrip hybrid coupler and the microstrip stub of the phase shifter are of the microstrip line type. However, also when any type of a dielectric waveguide such as a strip line type, a H-line dielectric waveguide, or a NRD dielectric waveguide is employed, the same effects as described above are achieved.

Further, while four antenna elements are employed in any of the above-mentioned embodiments, other number of antenna elements many be employed. For example, when a feeding line (transmission line) branches off into m lines through k branch stages from an input terminal to which a high-frequency power is applied (m=2ˆk (k-th power of 2), (k is an integer)), only m pieces of antenna elements are required, and the number Mₖ of phase shifters that are then required can be given by the following expression:
Mₖ=M₍ₖ₋1)×2+2ˆ(k−1) (when k≧1, M₁=1)

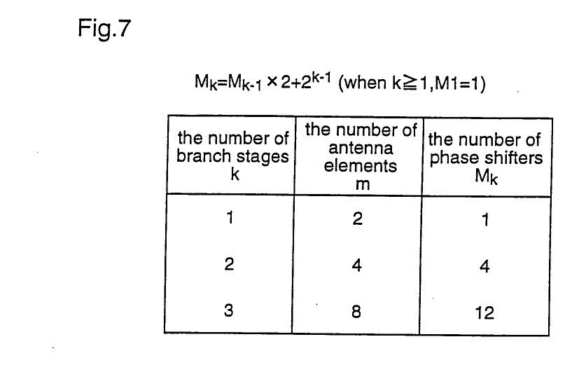

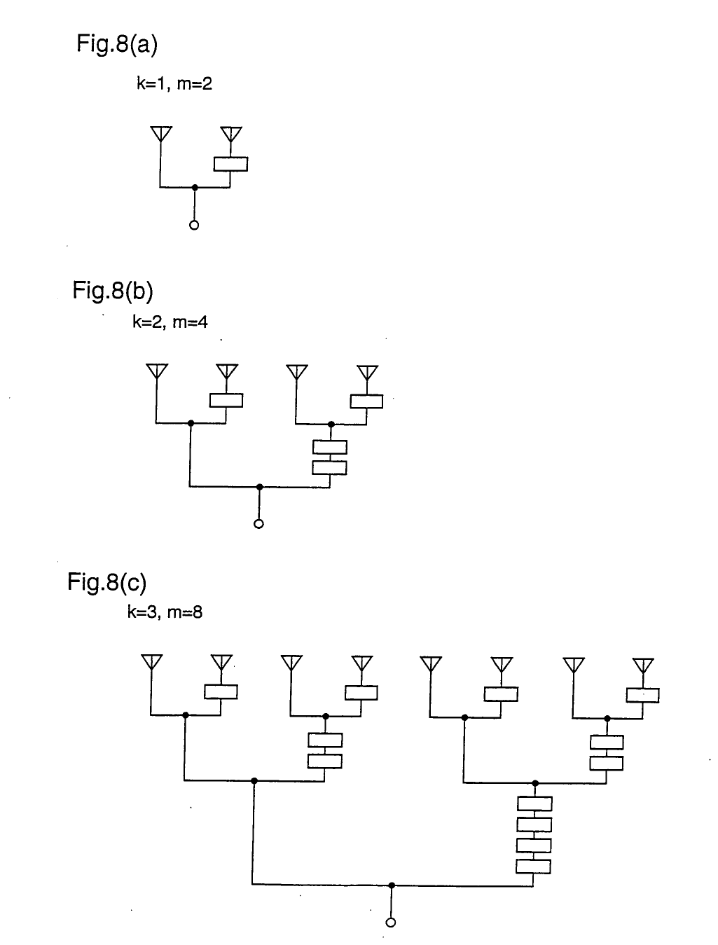

Hereinafter, a detailed explanation will be given with reference to FIGS. 7 and 8. FIG. 7 is a diagram showing the relationship of the number of branch stages (k), the number of antenna elements (m), and the number of phase shifters (Mₖ) in the antenna control unit or phased-array antenna according to the sixth embodiment. FIGS. 8 are diagrams showing arrangement of phase shifters in a case where k=1 and m=2 in FIG. 7 (FIG. 8(a)), a case where k=2 and m=4 (FIG. 8(b)), and a case where k=3 and m=8 (FIG. 8(c)).

For example, when the number of branch stages k=3, the number m of antenna elements is m=2ˆ3=8 as shown in FIG. 7, and the number M₃ of phase shifters is M₃=M₂×2+2ˆ=12. The phase shifters in this case are arranged as shown in FIG. 8(c) such that the number of phase shifters which are located between the (n+1)-th antenna terminal (0<n<8) and the input terminal is one larger than the number of phase shifters which are located between the n-th antenna terminal and the input terminal. For the sake of simplifying the explanation, only Mₖ phase shifters are shown in FIG. 8, but in the antenna control unit 300 as described in the third embodiment and the phased-array antenna 330 that employs this antenna control unit 300, Mₖ loss elements as many as the phase shifters are further disposed as shown in FIG. 3. In the case of the antenna control unit 400 as described in the fourth embodiment and the phased-array antenna 430 that employs this antenna control unit 400, when the Mₖ phase shifters shown in this figure are positive beam tilting phase shifters, Mₖ negative beam tilting phase shifters are further disposed as shown in FIG. 4.

### INDUSTRIAL AVAILABILITY

The antenna control unit and the phased-array antenna according to the present invention is quite useful in realizing a low-cost antenna control unit and phased-array antenna that has a pointed beam (large directivity gain) and a satisfactory beam tilt amount, as well as can be manufactured in fewer manufacturing processes. The antenna control unit and the phased-array antenna are particularly suitable for use in mobile unit identifying radio, or automobile collision avoidance radar.

1.-12. (canceled)

13. An antenna control unit including plural antenna terminals to which antenna elements are connected, a feeding terminal to which a high-frequency power is applied, and phase shifters which are connected to the respective antenna terminals by feeding lines that branch off from the feeding terminal and electrically change a phase of a high-frequency signal that passes through between the respective antenna terminals and the feeding terminal, said phase shifters being placed at some positions on the feeding lines, wherein
said phase shifter includes:
a hybrid coupler on a paraelectric transmission line layer that employs a paraelectric material as a base material; and
a stub on a ferroelectric transmission line layer that employs a ferroelectric material as a base material,
the paraelectric transmission line layer and the ferroelectric transmission line layer are laminated through a ground conductor, and the hybrid coupler and the stub are connected via a through hole that passes through the ground conductor, and
a distance between conductors that form a transmission line on the ferroelectric transmission line layer is larger than a distance between conductors that form a transmission line on the paraelectric transmission line layer.

14. An antenna control unit including plural antenna terminals to which antenna elements are connected, a feeding terminal to which a high-frequency power is applied, and phase shifters which are connected to the respective antenna terminals by feeding lines that branch off from the feeding terminal and electrically change a phase of a high-frequency signal that passes through between the respective antenna terminals and the feeding terminal, said phase shifters being placed at some positions on the feeding lines, wherein
said phase shifter includes:
a hybrid coupler on a paraelectric transmission line layer that employs a paraelectric material as a base material; and
a stub on a ferroelectric transmission line layer that employs a ferroelectric material as a base material,
the paraelectric transmission line layer and the ferroelectric transmission line layer are laminated through a ground conductor, and the hybrid coupler and the stub are electromagnetically connected via a coupling window that is formed on the ground conductor, and
a distance between conductors that form a transmission line on the ferroelectric transmission line layer is larger than a distance between conductors that form a transmission line on a paraelectric transmission line layer.

15. A phased-array antenna that includes, on a dielectric substrate: plural antenna elements; and an antenna control unit having a feeding terminal to which a high-frequency power is applied, and phase shifters that are connected with the respective antenna elements by feeding lines which branch off from the feeding terminal and electrically change a phase of a high-frequency signal that passes through between the respective antenna elements and the feeding terminal, said phase shifters being placed at some positions on the feeding lines, wherein
said phase shifter includes:
a hybrid coupler on a paraelectric transmission line layer that employs a paraelectric material as a base material; and
a stub on a ferroelectric transmission line layer that employs a ferroelectric material as a base material,
the paraelectric transmission line layer and the ferroelectric transmission line layer are laminated through a ground conductor, and the hybrid coupler and the stub are connected via a through hole that passes through the ground conductor, and
a distance between conductors that form a transmission line on the ferroelectric transmission line layer is larger than a distance between conductors that form a transmission line on the paraelectric transmission line layer.

16. A phased-array antenna that includes, on a dielectric substrate: plural antenna elements; and an antenna control unit having a feeding terminal to which a high-frequency power is applied, and phase shifters that are connected with the respective antenna elements by feeding lines which branch off from the feeding terminal and electrically change a phase of a high-frequency signal that passes through between the respective antenna elements and the feeding terminal, said phase shifters being placed at some positions on the feeding lines, wherein
said phase shifter includes:
a hybrid coupler on a paraelectric transmission line layer that employs a paraelectric material as a base material; and
a stub on a ferroelectric transmission line layer that employs a ferroelectric material as a base material,
the paraelectric transmission line layer and the ferroelectric transmission line layer are laminated through a ground conductor, and the hybrid coupler and the stub are electromagnetically connected via a coupling window that is formed in the ground conductor, and
a distance between conductors that form a transmission line on the ferroelectric transmission line layer is larger than a distance between conductors that form a transmission line on the paraelectric transmission line layer.

17. An antenna control unit including:
a feeding terminal to which a high-frequency power is applied;
a feeding line that branches off into m lines at a k-th branch stage from the feeding terminal when m=2ˆk (k-th power of 2) (m, k is an integer);
m antenna terminals for connecting antenna elements, which are provided on ends of the m feeding lines and arranged in a row, said antenna terminals being referred to as first, second, . . . , and m-th antenna terminals, respectively;
Mₖ phase shifters (Mₖ=M₍ₖ₋1)×2+2ˆ(k−1) when k≧1 and M₁=1) which all have the same characteristics and electrically change a phase of a high-frequency signal that passes through the feeding line; and
Mₖ loss elements which all have the same characteristics and have a transmission loss amount that is equal to a transmission loss amount of the phase shifter, wherein
the phase shifters are placed at some positions on the feeding line that branches off into m lines, such that the number of phase shifters which are located between a (n+1)-th antenna terminal (n is an integer that is from 1 to m−1) and the feeding terminal is one larger than the number of phase shifters which are located between an n-th antenna terminal and the feeding terminal, and
the loss elements are placed at some positions on the feeding line that branches off into m lines, such that the transmission loss amount from the n-th antenna terminal to the feeding terminal is larger than the transmission loss amount from the (n+1)-th antenna terminal to the feeding terminal, by a transmission loss amount corresponding to one phase shifter.

18. An antenna control unit including:
a feeding terminal to which a high-frequency power is applied;
a feeding line that branches off into m lines at a k-th branch stage from the feeding terminal when m=2ˆk (k-th power of 2) (m, k is an integer);
m antenna terminals for connecting antenna elements, which are provided on ends of the m feeding lines and arranged in a row, said antenna terminals being referred to as first, second, . . . , and m-th antenna terminals, respectively;
Mₖ positive beam tilting phase shifters (Mₖ=M₍ₖ₋1)×2+2ˆ(k−1) when k≧1 and M₁=1) which all have the same characteristics and electrically change a phase of a high-frequency signal that passes through the feeding line in a positive direction; and
Mₖ negative beam tilting phase shifters which all have the same characteristics and electrically change the phase of the high-frequency signal that passes through the feeding line in a negative direction, wherein
the positive beam tilting phase shifters are placed at some positions on the feeding line that branches off into m lines, such that the number of the positive beam tilting phase shifters which are located between an (n+1)-th antenna terminal (n is an integer from 1 to m−1) and the feeding terminal is one larger than the number of the positive beam tilting phase shifters which are located between an n-th antenna terminal to the feeding terminal, and
the negative beam tilting phase shifters are placed at some positions on the feeding line that branches off into m lines, such that the number of negative beam tilting phase shifters which are located between an n-th antenna terminal to the feeding terminal is one larger than the number of negative beam tilting phase shifters which are located between an (n+1)-th antenna terminal to the feeding terminal.

19. A two-dimensional antenna control unit including:
m₂ row antenna control units and one column antenna control unit,
said row antenna control unit being the antenna control unit of claim 17 including m=m₁ antenna terminals (m₁ is an integer), and
said column antenna control unit being the antenna control unit of claim 17 including m=m₂ antenna terminals (m₂ is an integer), wherein
feeding terminals of the m₂ row antenna control units are connected to the m₂ antenna terminals of the column antenna control unit, respectively.

20. A two-dimensional antenna control unit including:
m₂ row antenna control units and one column antenna control unit,
said row antenna control unit being the antenna control unit of claim 18 including m=m₁ antenna terminals (m₁ is an integer), and
said column antenna control unit being the antenna control unit of claim 18 including m=m₂ antenna terminals (m₂ is an integer), wherein
feeding terminals of the m₂ row antenna control units are connected to the m₂ antenna terminals of the column antenna control unit, respectively.

21. The phased-array antenna of claim 15 wherein said antenna control unit includes:
a feeding terminal to which a high-frequency power is applied;
a feeding line that branches off into m lines at a k-th branch stage from the feeding terminal when m=2ˆk (k-th power of 2) (m, k is an integer);
m antenna terminals for connecting antenna elements, which are provided on ends of the m feeding lines and arranged in a row, said antenna terminals being referred to as first, second, . . . , and m-th antenna terminals, respectively;
Mₖ phase shifters (Mₖ=M₍ₖ₋1)×2+2ˆ(k−1) when k≧1 and M₁=1) which all have the same characteristics and electrically change a phase of a high-frequency signal that passes through the feeding line; and
Mₖ loss elements which all have the same characteristics and have a transmission loss amount that is equal to a transmission loss amount of the phase shifter, wherein
the phase shifters are placed at some positions on the feeding line that branches off into m lines, such that the number of phase shifters which are located between a (n+1)-th antenna terminal (n is an integer that is from 1 to m−1) and the feeding terminal is one larger than the number of phase shifters which are located between an n-th antenna terminal and the feeding terminal, and
the loss elements are placed at some positions on the feeding line that branches off into m lines, such that the transmission loss amount from the n-th antenna terminal to the feeding terminal is larger than the transmission loss amount from the (n+1)-th antenna terminal to the feeding terminal, by a transmission loss amount corresponding to one phase shifter.

22. The phased-array antenna of claim 15 wherein said antenna control unit includes:
a feeding terminal to which a high-frequency power is applied;
a feeding line that branches off into m lines at a k-th branch stage from the feeding terminal when m=2ˆk (k-th power of 2) (m, k is an integer);
m antenna terminals for connecting antenna elements, which are provided on ends of the m feeding lines and arranged in a row, said antenna terminals being referred to as first, second, . . . , and m-th antenna terminals, respectively;
Mₖ positive beam tilting phase shifters (Mₖ=M(k−1)×2+2ˆ(k−1) when k≧1 and M₁=1) which all have the same characteristics and electrically change a phase of a high-frequency signal that passes through the feeding line in a positive direction; and
Mₖ negative beam tilting phase shifters which all have the same characteristics and electrically change the phase of the high-frequency signal that passes through the feeding line in a negative direction, wherein
the positive beam tilting phase shifters are placed at some positions on the feeding line that branches off into m lines, such that the number of the positive beam tilting phase shifters which are located between an (n+1)-th antenna terminal (n is an integer from 1 to m−1) and the feeding terminal is one larger than the number of the positive beam tilting phase shifters which are located between an n-th antenna terminal to the feeding terminal, and
the negative beam tilting phase shifters are placed at some positions on the feeding line that branches off into m lines, such that the number of negative beam tilting phase shifters which are located between an n-th antenna terminal to the feeding terminal is one larger than the number of negative beam tilting phase shifters which are located between an (n+1)-th antenna terminal to the feeding terminal.

23. A phased-array antenna that includes, on a dielectric substrate: plural antenna elements; and an antenna control unit having a feeding terminal to which a high-frequency power is applied, and phase shifters that are connected with the respective antenna elements by feeding lines which branch off from the feeding terminal and electrically change a phase of a high-frequency signal that passes through between the respective antenna elements and the feeding terminal, said phase shifters being placed at some positions on the feeding lines, wherein
said phase shifter includes:
a hybrid coupler on a paraelectric transmission line layer that employs a paraelectric material as a base material; and
a stub on a ferroelectric transmission line layer that employs a ferroelectric material as a base material,
the paraelectric transmission line layer and the ferroelectric transmission line layer are laminated through a ground conductor, and the hybrid coupler and the stub are connected via a through hole that passes through the ground conductor, and
a distance between conductors that form a transmission line on the ferroelectric transmission line layer is larger than a distance between conductors that form a transmission line on the paraelectric transmission line layer;
wherein said antenna control unit is a two-dimensional antenna control unit including:
m₂ row antenna control units and one column antenna control unit,
said row antenna control unit being the antenna control unit of claim 17 including m=m₁ antenna terminals (m₁ is an integer), and
said column antenna control unit being the antenna control unit of claim 17 including m=m₂ antenna terminals (m₂ is an integer), wherein
feeding terminals of the m₂ row antenna control units are connected to the m₂ antenna terminals of the column antenna control unit, respectively.

24. A phased-array antenna that includes, on a dielectric substrate: plural antenna elements; and an antenna control unit having a feeding terminal to which a high-frequency power is applied, and phase shifters that are connected with the respective antenna elements by feeding lines which branch off from the feeding terminal and electrically change a phase of a high-frequency signal that passes through between the respective antenna elements and the feeding terminal, said phase shifters being placed at some positions on the feeding lines, wherein
said phase shifter includes:
a hybrid coupler on a paraelectric transmission line layer that employs a paraelectric material as a base material; and
a stub on a ferroelectric transmission line layer that employs a ferroelectric material as a base material,
the paraelectric transmission line layer and the ferroelectric transmission line layer are laminated through a ground conductor, and the hybrid coupler and the stub are connected via a through hole that passes through the ground conductor, and
a distance between conductors that form a transmission line on the ferroelectric transmission line layer is larger than a distance between conductors that form a transmission line on the paraelectric transmission line layer;
wherein said antenna control unit is a two-dimensional antenna control unit including:
m₂ row antenna control units and one column antenna control unit,
said row antenna control unit being the antenna control unit of claim 18 including m=m₁ antenna terminals (m₁ is an integer), and
said column antenna control unit being the antenna control unit of claim 18 including m=m₂ antenna terminals (m₂ is an integer), wherein
feeding terminals of the m₂ row antenna control units are connected to the m₂ antenna terminals of the column antenna control unit, respectively.

25. The phased-array antenna of claim 16 wherein said antenna control unit includes:
a feeding terminal to which a high-frequency power is applied;
a feeding line that branches off into m lines at a k-th branch stage from the feeding terminal when m=2ˆk (k-th power of 2) (m, k is an integer);
m antenna terminals for connecting antenna elements, which are provided on ends of the m feeding lines and arranged in a row, said antenna terminals being referred to as first, second, . . . , and m-th antenna terminals, respectively;
Mₖ phase shifters (Mₖ=M₍ₖ₋1)×2+2ˆ(k−1) when k≧1 and M=1) which all have the same characteristics and electrically change a phase of a high-frequency signal that passes through the feeding line; and
Mₖ loss elements which all have the same characteristics and have a transmission loss amount that is equal to a transmission loss amount of the phase shifter, wherein
the phase shifters are placed at some positions on the feeding line that branches off into m lines, such that the number of phase shifters which are located between a (n+1)-th antenna terminal (n is an integer that is from 1 to m−1) and the feeding terminal is one larger than the number of phase shifters which are located between an n-th antenna terminal and the feeding terminal, and
the loss elements are placed at some positions on the feeding line that branches off into m lines, such that the transmission loss amount from the n-th antenna terminal to the feeding terminal is larger than the transmission loss amount from the (n+1)-th antenna terminal to the feeding terminal, by a transmission loss amount corresponding to one phase shifter.

26. The phased-array antenna of claim 16 wherein said antenna control unit includes:
a feeding terminal to which a high-frequency power is applied;
a feeding line that branches off into m lines at a k-th branch stage from the feeding terminal when m=2ˆk (k-th power of 2) (m, k is an integer);
m antenna terminals for connecting antenna elements, which are provided on ends of the m feeding lines and arranged in a row, said antenna terminals being referred to as first, second, . . . , and m-th antenna terminals, respectively;
Mₖ positive beam tilting phase shifters (Mₖ=M(k−1)×2+2ˆ(k−1) when k≧1 and M₁=1) which all have the same characteristics and electrically change a phase of a high-frequency signal that passes through the feeding line in a positive direction; and
Mₖ negative beam tilting phase shifters which all have the same characteristics and electrically change the phase of the high-frequency signal that passes through the feeding line in a negative direction, wherein
the positive beam tilting phase shifters are placed at some positions on the feeding line that branches off into m lines, such that the number of the positive beam tilting phase shifters which are located between an (n+1)-th antenna terminal (n is an integer from 1 to m−1) and the feeding terminal is one larger than the number of the positive beam tilting phase shifters which are located between an n-th antenna terminal to the feeding terminal, and
the negative beam tilting phase shifters are placed at some positions on the feeding line that branches off into m lines, such that the number of negative beam tilting phase shifters which are located between an n-th antenna terminal to the feeding terminal is one larger than the number of negative beam tilting phase shifters which are located between an (n+1)-th antenna terminal to the feeding terminal.

27. A phased-array antenna that includes, on a dielectric substrate: plural antenna elements; and an antenna control unit having a feeding terminal to which a high-frequency power is applied, and phase shifters that are connected with the respective antenna elements by feeding lines which branch off from the feeding terminal and electrically change a phase of a high-frequency signal that passes through between the respective antenna elements and the feeding terminal, said phase shifters being placed at some positions on the feeding lines, wherein
said phase shifter includes:
a hybrid coupler on a paraelectric transmission line layer that employs a paraelectric material as a base material; and
a stub on a ferroelectric transmission line layer that employs a ferroelectric material as a base material,
the paraelectric transmission line layer and the ferroelectric transmission line layer are laminated through a ground conductor, and the hybrid coupler and the stub are electromagnetically connected via a coupling window that is formed in the ground conductor, and
a distance between conductors that form a transmission line on the ferroelectric transmission line layer is larger than a distance between conductors that form a transmission line on the paraelectric transmission line layer;
wherein said antenna control unit is a two-dimensional antenna control unit including:
m₂ row antenna control units and one column antenna control unit, said row antenna control unit being the antenna control unit of claim 17 including m=m₁ antenna terminals (m₁ is an integer), and
said column antenna control unit being the antenna control unit of claim 17 including m=m₂ antenna terminals (m₂ is an integer), wherein
feeding terminals of the m₂ row antenna control units are connected to the m₂ antenna terminals of the column antenna control unit, respectively.

28. A phased-array antenna that includes, on a dielectric substrate: plural antenna elements; and an antenna control unit having a feeding terminal to which a high-frequency power is applied, and phase shifters that are connected with the respective antenna elements by feeding lines which branch off from the feeding terminal and electrically change a phase of a high-frequency signal that passes through between the respective antenna elements and the feeding terminal, said phase shifters being placed at some positions on the feeding lines, wherein
said phase shifter includes:
a hybrid coupler on a paraelectric transmission line layer that employs a paraelectric material as a base material; and
a stub on a ferroelectric transmission line layer that employs a ferroelectric material as a base material,
the paraelectric transmission line layer and the ferroelectric transmission line layer are laminated through a ground conductor, and the hybrid coupler and the stub are electromagnetically connected via a coupling window that is formed in the ground conductor, and
a distance between conductors that form a transmission line on the ferroelectric transmission line layer is larger than a distance between conductors that form a transmission line on the paraelectric transmission line layer;
wherein said antenna control unit is a two-dimensional antenna control unit including:
m₂ row antenna control units and one column antenna control unit,
said row antenna control unit being the antenna control unit of claim 18 including m=m₁ antenna terminals (m₁ is an integer), and
said column antenna control unit being the antenna control unit of claim 18 including m=m₂ antenna terminals (m₂ is an integer), wherein
feeding terminals of the m₂ row antenna control units are connected to the m₂ antenna terminals of the column antenna control unit, respectively.
